(19) United States
(12) Patent Application Publication
(10) Pub. No.: US 2025/0117958 A1
(43) Pub. Date: Apr. 10, 2025

(54) IMAGE MEASURING APPARATUS AND PROGRAM

(71) Applicant: MITUTOYO CORPORATION, Kanagawa (JP)

(72) Inventors: Hiroyuki Yoshida, Kanagawa (JP); Yuji Sadahira, Kanagawa (JP); Yuki Yamasaki, Kanagawa (JP)

(21) Appl. No.: 18/908,877

(22) Filed: Oct. 8, 2024

(30) Foreign Application Priority Data
Oct. 10, 2023 (JP) 2023-175470

(51) Int. Cl. G06T 7/60

(52) U.S. Cl. CPC G06T 7/60; G06T 2200/24; G06T 2207/20092

(57) ABSTRACT

An image measuring apparatus and a program with good operability even when the information display screen is small or the operator's skill level is low is provided. An image measuring apparatus according to the present invention captures an image of a measurement object and measures the dimensions of the measurement object through a plurality of operation steps. The image measuring apparatus comprises: a display unit that displays user interfaces that accept inputs through input operations by an operator; a process control unit that causes the display unit to display only the user interfaces that accept the inputs necessary to use the available functions in each of the operation steps; and a function execution unit that executes the function for which the input related to use is made on the user interface.

### CROSS-REFERENCE TO RELATED APPLICATION

This non-provisional application claims priority under 35 U.S.C. § 119 (a) from Japanese Patent Application No. 2023-175470, filed on Oct. 10, 2023, the entire contents of which are incorporated herein by reference.

### BACKGROUND OF THE INVENTION

### Field of the Invention

The present invention relates to an image measuring apparatus and program.

### Description of the Related Art

An image measuring apparatus is a device that captures an image of a measurement object and measures the dimensions of the measurement object by analyzing the image (see, for example, JP2010-169584A).

### SUMMARY OF THE INVENTION

### Problems To Be Solved By the Invention

Conventionally, applications for image measuring apparatus that control image measuring apparatus have displayed user interfaces on a display screen for all functions to input instructions for the use of the functions provided by the application. Therefore, when the display screen is small, the area displaying the user interfaces occupies a high percentage of the screen, resulting in a situation where the area displaying the image of the measurement object is very small or it is difficult to know which functions are available when the operator's skill level is low, which hinders operability.

An object of the present invention is to provide an image measuring apparatus and a program with good operability even when the screen for displaying information is small or the operator's skill level is low.

### Means For Solving the Problems

An image measuring apparatus according to the present invention captures an image of a measurement object and measures the dimensions of the measurement object through a plurality of operation steps. The image measuring apparatus comprises: a display unit that displays user interfaces that accept inputs through input operations by an operator; a process control unit that causes the display unit to display only the user interfaces that accept the inputs necessary to use the available functions in each of the operation steps; and a function execution unit that executes the function for which the input related to use is made on the user interface.

The plurality of operation steps may include a first operation step to sequentially extract a plurality of geometric elements from the image of the measurement object and a second operation step to obtain measurement results by performing dimensional measurement sequentially from measurement items for which the geometric elements necessary for measurement have been obtained through the extraction of the geometric elements in the first operation step.

The functions of the image measuring apparatus of the present invention may be described in a program, and the functions of the image measuring apparatus of the present invention may be realised by making a computer execute the program.

### Effect of the Invention

According to the image measuring apparatus and program, when the operator performs an input operation, user interfaces are displayed to input instructions for the use of functions limited to the available functions. Thereby, the area displaying the user interfaces occupies a smaller proportion of the display screen, allowing a relatively large area for displaying the image of the measurement object and improving the operability of the extraction of geometric elements. In addition, by displaying the user interfaces limited to the available functions, even less-skilled operators can easily find the functions they want to use, thereby improving operability.

### BRIEF DESCRIPTION OF THE DRAWINGS

FIG. 1 shows an example of the appearance of an image measuring apparatus 1 that performs the image measurement method according to the present invention.

FIG. 2 shows a schematic diagram of the internal structure of the image measuring apparatus 1.

FIG. 3 shows a functional block diagram of the image measuring apparatus 1.

FIG. 4 shows an example of the user interfaces in operation step S1.

FIG. 5 shows an example of the user interfaces in operation step S2.

FIG. 6 shows an example of the user interfaces in operation step S3.

FIG. 7 shows an example of the user interfaces in operation step S3 in a different view.

### DETAILED DESCRIPTION OF THE EMBODIMENTS

Hereinafter, embodiments of the present invention will be described with reference to the drawings. In the following description and drawings, the same reference numeral is attached to the same functional parts, and the functional parts once explained are either omitted or explained to the extent necessary.

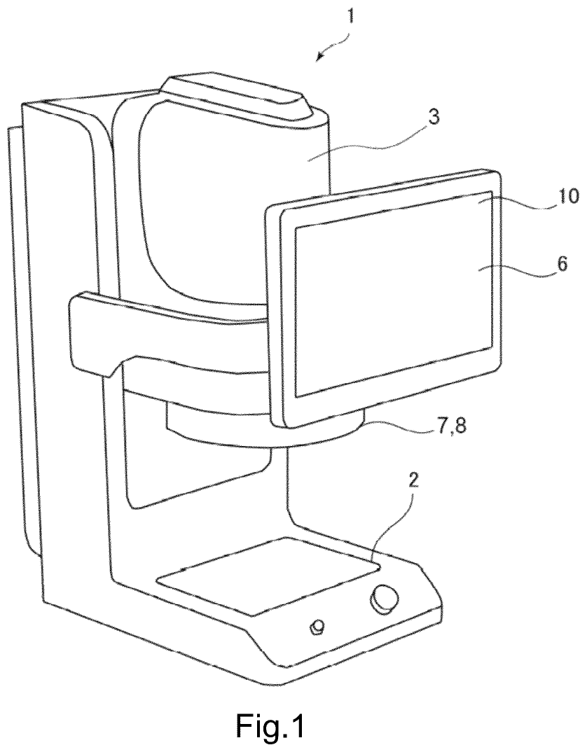

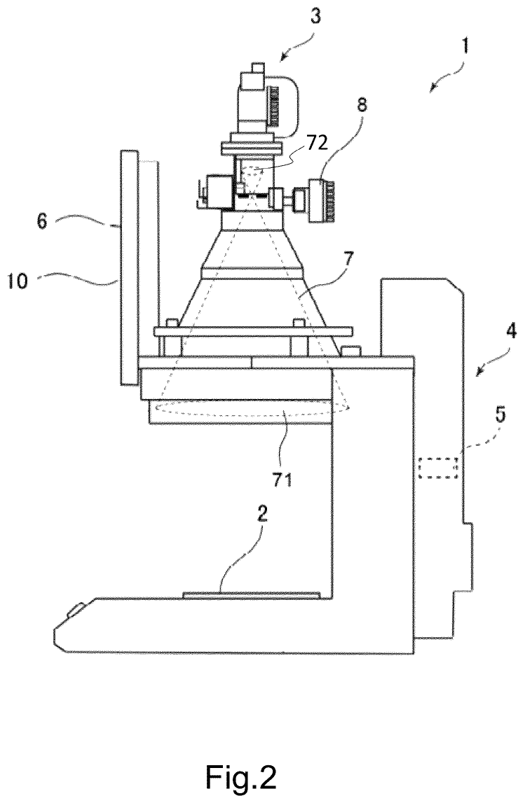

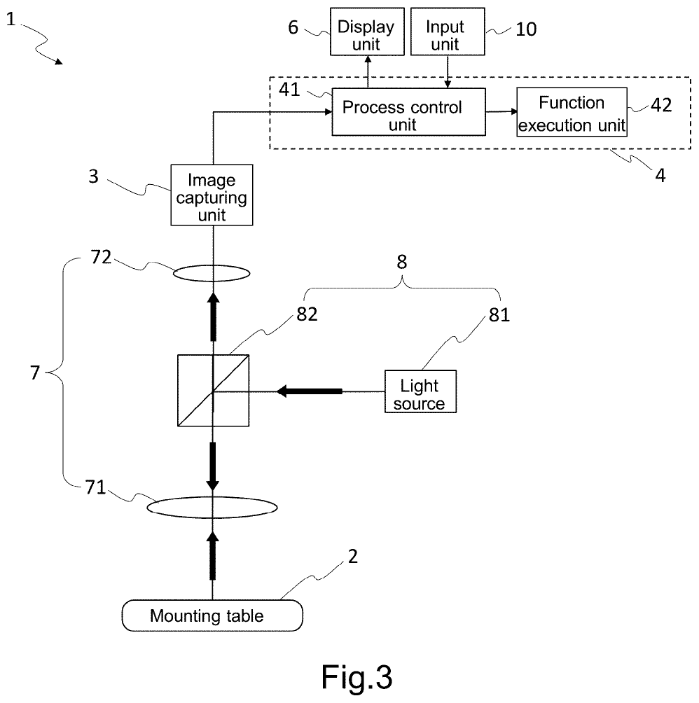

FIG. 1 is a schematic diagram showing an example of the appearance of an image measuring apparatus 1. FIG. 2 is a schematic diagram showing the internal structure of the image measuring apparatus 1. FIG. 3 shows a functional block diagram of the image measuring apparatus 1. In the present embodiment, the case in which the coaxial episcopic illumination is adopted as the illumination method will be explained as an example, but any illumination method is acceptable as long as the image of the measurement object can be captured.

An image measuring apparatus according to the present invention captures an image of a measurement object and measures the dimensions of the measurement object through a plurality of operation steps.

The image measuring apparatus 1 includes a mounting table 2, an image capturing unit 3, a control and calculation unit 4, a memory unit 5, a display unit 6, a telecentric optical system 7, an illumination unit 8, and an input unit 10.

The mounting table 2 is a platform on which a measurement object (not shown in the drawings) is placed.

The image capturing unit 3 is disposed opposite the mounting table 2 and captures images of the measurement object mounted on the mounting table 2 by receiving light from the direction of the mounting table 2. The image capturing unit 3 includes an image sensor, which converts the brightness or darkness of an image formed on its light-receiving surface into an electrical signal, thereby generating image data. For the image sensor, a semiconductor solid-state imaging device such as CCD (Charge-Coupled Device) or CMOS (Complementary Metal Oxide Semiconductor) is used.

The memory unit 5 is an arbitrary storage means capable of storing digital data.

The telecentric optical system 7 includes an objective lens 71 that collects light from the direction of the mounting table 2 and an imaging lens 72 that forms an image of the light arriving through the objective lens 71 on the light-receiving surface of the image capturing unit 3. The objective lens 71 and the imaging lens 72 may have a plurality of lens surfaces, respectively. Note that the image measuring apparatus 1 may be equipped with another optical system in place of the telecentric optical system 7.

The illumination unit 8 is a coaxial episcopic illumination means provided with a light source 81 that emits illumination light and a beam splitter 82 that interrupts the illumination light from the light source 81 into the telecentric optical system 7 and directs the light toward the mounting table 2 as coaxial episcopic illumination light whose optical axis coincides with that of the image capturing unit 3. The illumination unit 8 may be equipped with transillumination or side illumination in addition to the coaxial episcopic illumination for image clarity and other purposes.

The display unit 6 is an arbitrary display means and displays images of the measurement object captured by the image capturing unit 3 and user interfaces that accept input by the operator based on control by the display control unit.

The input unit 10 is an input means by which information is manually input. FIGS. 1 and 2 show an example in which a touch panel display is employed and configured integrally with the display unit 6, but the input unit 10 may be configured as an independent input means, such as a mouse or keyboard. If a touch panel display is employed, the input unit 10 accepts input of the touched position or the region traced by the operator's finger. If a mouse is employed, the input unit 10 accepts input on the position of the pointer when the operator clicks the button, the region traced by the pointer while pressing the button, or the like.

The control and calculation unit 4 controls each part in the image measuring apparatus 1 to realize image capture and image measurement by the image measuring apparatus 1.

In the present invention, the control and calculation unit 4 includes a process control unit 41 and a function execution unit 42.

The process control unit 41 causes the display unit 6 to display only the user interfaces that accept inputs necessary for the use of the available functions in each of the operation steps performed by the operator in image measurement using the image measuring apparatus 1. The user interfaces are typically graphical user interfaces (GUI), such as buttons, but they can be something else, such as menu bars or toolbars.

The user interfaces may be displayed automatically upon entering each operation step, or it may wait for the user to enter some trigger to display the user interfaces. If the user interfaces cannot be fully displayed even if they are limited to the available functions, for example, the user interfaces pertaining to functions that are frequently used based on the past operation history may be displayed with priority.

The process control unit 41 accepts the input by the operator necessary for using the function via the user interface from the input unit 10 in each operation step and causes the function execution unit 42 to execute the concerned function.

The operation steps include, for example, an operation step to be performed when the measurement object is placed on the mounting table 2 and measurement is started (hereinafter referred to as “operation step S1”), an operation step to be performed when one of the measurement items is selected in operation step S1 (hereinafter referred to as “operation step S2”) and an operation step to be performed when measuring dimensions from geometric elements extracted from the image of the measurement object (hereinafter referred to as “operation step S3”).

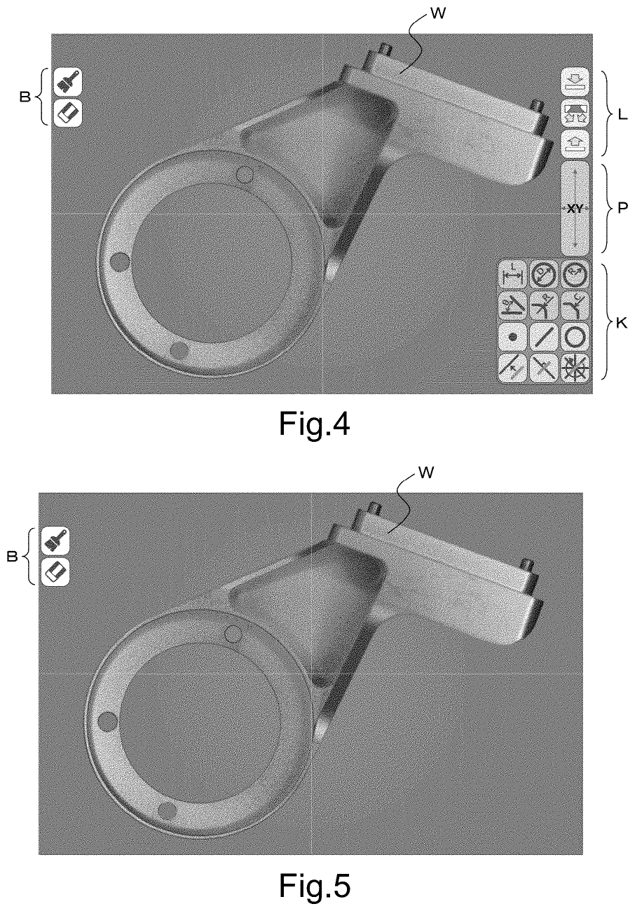

Functions available in the operation step S1 include, for example, the selection of measurement items such as various length and angle dimensions, selection of tools such as brushes and erasers for extraction of geometric elements, adjustment of the image capture position, adjustment of illumination, and the like. Hence, in operation step S1, the user interfaces limited to the functions available in that operation step, such as buttons to accept the selection of measurement items and tools, buttons to call the user interface for adjusting the image capture position and illumination, etc., are displayed on the display unit 6. FIG. 4 shows an example of a display form of the user interfaces in the operation step S1. In FIG. 4, an example is shown in which the measurement item selection button K, the tool selection button B, the call button P for the image capture position adjustment tool, and the call button L for the illumination adjustment tool are displayed as user interfaces along with the image of the measurement object W. However, specific display items and display forms are not limited to those depicted in FIG. 4.

When one or more measurement items are selected in the operation step S1, the process goes to the operation step S2. On the other hand, when the brush tool for extracting geometric elements is selected, the process enters a state waiting for input by the operator. When geometric elements are sequentially identified by the operator's operation of the input unit 10, such as tracing the image of the measurement object, the geometric elements are sequentially extracted, and their edges are detected. In this sense, when the brush tool is selected, operation step S1 can be considered an operation step for sequentially extracting geometric elements.

When the process moves to the operation step S2, the functions available in the operation step S2 include, for example, the selection of tools such as brushes and erasers to extract geometric elements. Hence, in the operation step S2, the user interfaces limited to the functions available in this operation step, such as buttons that accept the selection input of these tools, are displayed on the display unit 6. FIG. 5 shows an example of a display form of the user interfaces in the operation step S2. In FIG. 5, an example is shown in which the tool selection buttons B are displayed as the user interfaces along with the image of the measurement object W. However, specific display items and display forms are not limited to those depicted in FIG. 5.

When the brush tool for extracting geometric elements is selected in the operation step S2, the process enters a state waiting for input by the operator. When geometric elements are sequentially identified by the operator's operation of the input unit 10, such as tracing the image of the measurement object, the geometric elements are sequentially extracted, and their edges are detected. The dimensional measurement is performed based on the edges detected for each extracted geometric element. For example, if the measurement item is the diameter dimension of a circle, the number of geometric elements needed is one, and if the measurement item is the distance dimension between two lines or the angle dimension between two lines, the number of geometric elements needed is two.

In parallel with the extraction of geometric elements in the operation step S1 or the operation step S2, the operation step S3 for dimension measurement based on the extracted geometric elements is executed.

Functions available in the operation step S3 include, for example, the selection of the measurement item, such as various length dimensions and angle dimensions. In addition, since these functions can be executed in parallel with the extraction of geometric elements in operation step S1 and operation step S2, the selection of tools such as brushes and erasers also needs to be available. Hence, in the operation step S3, the user interfaces limited to the functions available in this operation step, such as buttons that accept selection of measurement items and tools, are displayed on the display unit 6.

In the case where geometric elements are extracted in operation step S1, no measurement items are identified. Therefore, if one or more measurement items are selected in the operation step S3 and the geometric elements necessary for the measurement of the selected measurement items have been extracted, the measurement is executed, and the measurement results are output to the display unit 6 or other devices. If the extracted geometric elements are insufficient, the extraction of geometric elements in the operation step S1 is continued, and when the necessary geometric elements have been extracted, the measurement results are output to the display unit 6 or other devices.

If no measurement item is specified, the geometric elements may be sequentially extracted in operation step S1, and in parallel, in operation step S3, the measurement may be performed sequentially starting from the measurement item for which the geometric elements necessary for the measurement are obtained through the extraction of geometric elements in the operation step S1, and the measurement results may be sequentially output to display unit 6 or other devices. In this case, for example, a button or the like may be automatically set to a selected state for each measurement item for which a measurement result is obtained, and the other button or the like may be configured so that unnecessary measurement results can be excluded by deselecting the button or the like.

On the other hand, if the measurement item is selected in the operation step S1, geometric elements are sequentially extracted in the operation step S2, and once the geometric elements necessary for the measurement of the concerned measurement item are obtained, the measurement is performed in operation step S3 and the measurement results are output to display unit 6, or other device. If several measurement items are selected in the operation step S2, geometric elements necessary for measurement are sequentially extracted, and the measurement results are output to the display 6 or other devices, by executing the operation step S3, starting with the measurement item for which the extraction of geometric elements necessary for measurement has been completed, or once the extraction of geometric elements necessary for all the selected measurement items has been completed.

FIG. 6 shows an example of a display form of the user interfaces in operation step S3. In FIG. 6, an example is shown in which the measurement item selection buttons K and the tool selection buttons B are displayed as user interfaces along with the image of the measurement object W. However, specific display items and display forms are not limited to those depicted in FIG. 6. Since the extraction of geometric elements has already progressed at this stage, the two extracted geometric elements, E1 and E2, are also displayed.

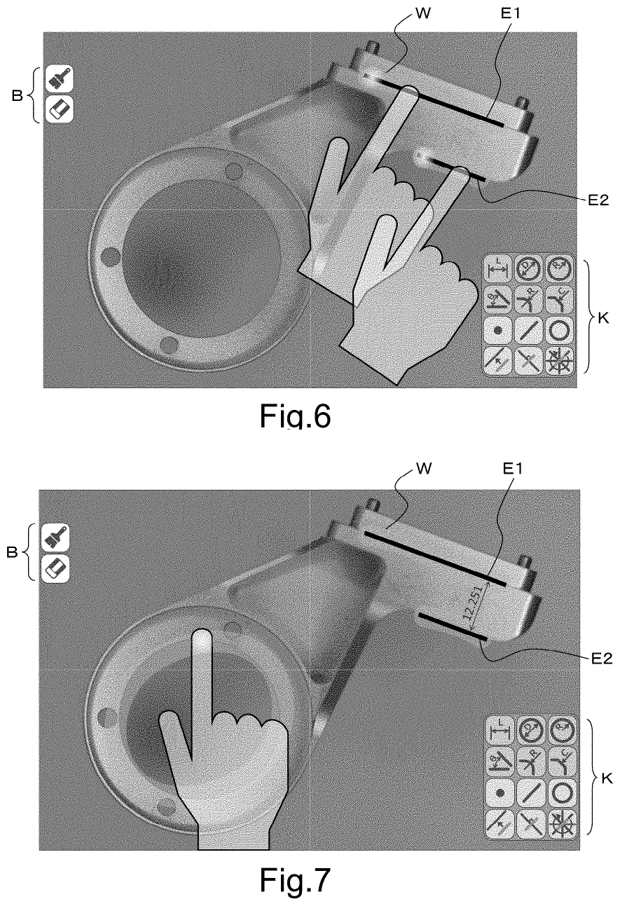

FIG. 7 shows an example of the display state in the process of extracting the next geometric element after two straight lines, E1 and E2, have been extracted. Since the geometric elements necessary for measuring the length dimension between the two straight lines have already been extracted, the measurement is executed, and the length dimension is displayed in FIG. 7.

In the image measuring apparatus of the present invention, the control and calculation unit 4 may be constituted by a CPU, and each function may be realized by executing a program (an application for image measuring apparatus) that describes the functions of the process control unit 41 and the function execution unit 42, as well as the functions to control the image capturing unit 3, the illumination unit 8, etc., by the CPU. The program may be read from the memory unit 5 and executed, or it may be read from another storage means and executed. The control and calculation unit 4 and the memory unit 5 may be provided in the main body of the image measuring apparatus 1 or in a personal computer or other device that is communicatively connected to the main body of the image measuring apparatus 1.

According to the image measuring apparatus and program of the present invention described above, when the operator performs an input operation, the user interfaces are displayed to input instructions for using functions limited to the available functions. Thereby, the area displaying the user interfaces occupies a smaller proportion of the display screen, allowing a relatively large area for displaying the image of the measurement object and improving the operability, such as the designation of the measurement part. In addition, by displaying the user interfaces limited to the available functions, even less-skilled operators can easily find the functions they want to use, thereby improving operability.

The present invention is not limited to the above embodiments and variations. The above-mentioned embodiments and variations are examples only, and anything having a configuration substantially the same as the technical idea described in the claims of the present invention and producing similar effects is included in the technical scope of the present invention. In other words, changes can be made as appropriate within the scope of the technical ideas expressed in the present invention, and forms with such changes and improvements are also included in the technical scope of the present invention.

What is claimed is:

1. An image measuring apparatus that captures an image of a measurement object and measures the dimensions of the measurement object through a plurality of operation steps, comprising:
a display unit that displays user interfaces that accept inputs through input operations by an operator;
a process control unit that causes the display unit to display only the user interfaces that accept the inputs necessary use the available functions in each of the operation steps; and
a function execution unit that executes the function for which the input related to use is made on the user interface.

2. The image measuring apparatus according to claim 1, wherein
the plurality of operation steps includes:
a first operation step to sequentially extract a plurality of geometric elements from the image of the measurement object; and
a second operation step to obtain measurement results by performing dimensional measurement sequentially from measurement items for which the geometric elements necessary for measurement have been obtained through the extraction of the geometric elements in the first operation step.

3. The program that causes a computer to function as the image measuring apparatus as claimed in claim 1.
